(19) United States
(12) Patent Application Publication
(10) Pub. No.: US 2023/0264671 A1
(43) Pub. Date: Aug. 24, 2023

(54) Hydraulic Block for a Hydraulic Assembly for a Traction Control System of a Hydraulic Vehicle Braking System

(71) Applicant: Robert Bosch GmbH, Stuttgart (DE)

(72) Inventors: Thomas Zander, Oberstaufen (DE); Michael Loeffler, Oberstaufen (DE)

(21) Appl. No.: 18/005,433

(22) PCT Filed: Mar. 31, 2021
(86) PCT No.: PCT/EP2021/058417

§ 371 Date: Jan. 13, 2023

(30) Foreign Application Priority Data
Jul. 17, 2020 (DE) 10 2020 208 958.2

(51) Int. Cl. B60T 17/00; F15B 13/02

(52) U.S. Cl. CPC B60T 17/00; F15B 13/02; B60T 2270/203; B60T 13/686

(57) ABSTRACT

Receptacles for a pressure-change damper and for a throttle are provided, at an offset to each other and at an offset to a receptacle for a hydraulic pump, in opposite sides of a hydraulic block for a hydraulic assembly of a traction control system of a hydraulic vehicle braking system, whereby a greater volume of the pressure-change damper and thus better damping are possible.

The invention relates to a hydraulic block having the features of the preamble of claim 1.

### PRIOR ART

Hydraulic blocks of this kind are used to mechanically fasten and hydraulically interconnect hydraulic components of a slip control system of a hydraulic vehicle braking system. Hydraulic components of this kind are, inter alia, solenoid valves, check valves, hydraulic accumulators, pressure-change dampers, throttles, pressure sensors and hydraulic pumps. The hydraulic block is connected to a master brake cylinder via one or more brake lines and hydraulic wheel brakes are connected to the hydraulic block via brake lines. For vehicle power-braking systems, in particular, it is known to integrate the master brake cylinder into the hydraulic block, i.e. to make a master brake cylinder bore in the hydraulic block in order to accommodate one or more master brake cylinder pistons, instead of connecting the hydraulic block to a master brake cylinder.

Slip control systems are, for example, anti-lock braking systems, traction control systems and/or dynamic stability control/electronic stability programs for which the abbreviations ABS, TCS and/or DSC/ESP are common. Slip control systems are known and are not explained here. The hydraulic block may also comprise a receptacle for a power brake pressure generator, for example a receptacle for a piston-cylinder unit for generating a brake pressure by means of an external force.

The hydraulic components are fastened in receptacles in the hydraulic block, which are usually designed as cylindrical through-holes or blind holes, some of which have diametrical steps. “Hydraulic interconnection” means that the receptacles or the hydraulic components fastened therein are connected by lines in the hydraulic block according to a hydraulic circuit diagram of the vehicle braking system or the slip control system thereof. The lines are typically bored in the hydraulic block. The receptacles and the lines connecting them in the hydraulic block are also referred to as the bored elements of the hydraulic block.

When equipped with the hydraulic components of the slip control system, the hydraulic block forms a hydraulic assembly, “equipped” meaning that the hydraulic components are fastened in the receptacles of the hydraulic block provided for them in each case and are sealed in a pressure-tight manner by normal means.

A hydraulic block of this kind is known from laid-open application DE 10 2006 059 924 A1.

### DISCLOSURE OF THE INVENTION

The hydraulic block according to the invention having the features of claim 1 is intended for a hydraulic assembly for a slip control system of a hydraulic vehicle braking system. The hydraulic block comprises, inter alia, receptacles for valves, in particular for solenoid valves of the slip control system, and a receptacle for a hydraulic pump, in particular for a so-called return pump. The hydraulic block preferably comprises a receptacle for a hydraulic pump for each brake circuit of the vehicle braking system. The hydraulic pump is used to generate a brake pressure for a slip control system and to increase the brake pressure in wheel brakes of the vehicle braking system after a reduction of the brake pressure in the wheel brakes and to return brake fluid from the wheel brakes in the direction of a master brake cylinder during slip control. In addition, the hydraulic block comprises a receptacle for a pressure-change damper in one side of the hydraulic block and a receptacle for a throttle in another side, preferably an opposite side of the hydraulic block. The pressure-change damper is connected to a delivery side of the hydraulic pump and the throttle is likewise connected to the delivery side of the hydraulic pump and/or to the pressure-change damper. The pressure-change damper dampens pressure changes in the brake fluid on the delivery side of the hydraulic pump; in particular, the pressure-change damper is intended for damping pressure pulses caused by an oscillating conveyance of brake fluid by means of the hydraulic pump and for damping sudden pressure changes caused by switching solenoid valves of the slip control system. Preferably, the receptacles for the hydraulic pump, the pressure-change damper, and/or the throttle are arranged at an offset to one another in the hydraulic block, such that they extend past one another or intersect one another. The offset of the receptacle for the pressure-change damper with respect to the receptacle for the hydraulic pump and/or with respect to the receptacle for the throttle allows for a larger volume of the pressure-change damper or rather a larger volume of the pressure-change damper within the hydraulic block, as a result of which its damping effect is improved or can be improved.

The dependent claims provide developments and advantageous embodiments of the invention specified in the independent claim.

All of the features disclosed in the description and the drawing can be implemented individually or, in principle, in any combination in embodiments of the invention. Embodiments of the invention that do not have all of the features, but rather only one or more features of a claim or an embodiment of the invention are possible, in principle.

### BRIEF DESCRIPTION OF THE DRAWINGS

The invention is explained in more detail below with reference to an embodiment shown in the drawing. In the drawings:

FIG. 1 is a hydraulic circuit diagram of a hydraulic vehicle braking system having a slip control system;

FIG. 2 is a perspective view of a partially equipped hydraulic block according to the invention for a hydraulic assembly of the vehicle braking system from FIG. 1;

FIG. 3 shows the hydraulic block from FIG. 2 unequipped from another viewing direction; and

FIG. 4 is a longitudinal section of the hydraulic block from FIGS. 2 and 3 through a receptacle for a pressure-change damper and through a receptacle for a throttle.

### EMBODIMENT OF THE INVENTION

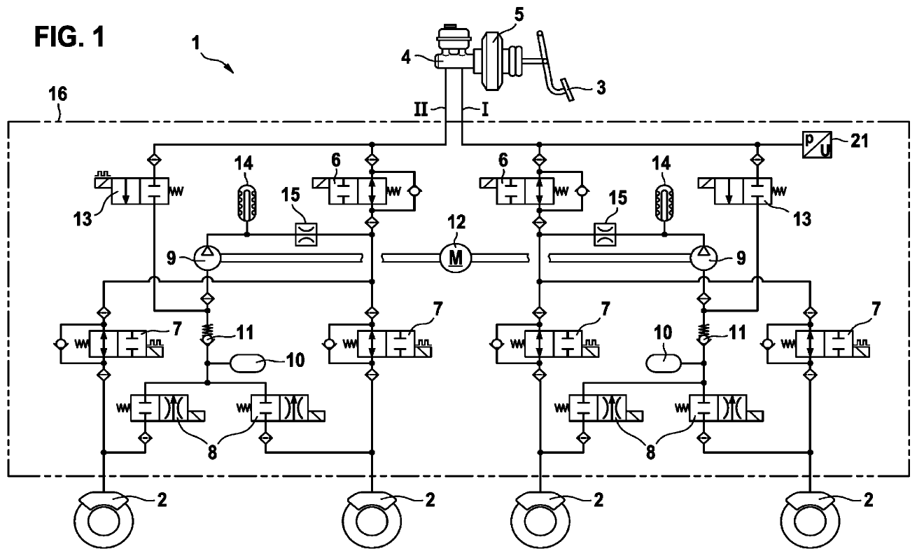

The vehicle braking system 1 shown in FIG. 1 is designed as a dual-circuit braking system comprising four hydraulic wheel brakes 2, two of which are connected to one of the two brake circuits I, II in each case. Said braking system comprises a master brake cylinder 4, which can be actuated by muscle power, i.e. by means of a foot brake pedal 3 in the embodiment shown here, and which may comprise but does not have to comprise a brake booster 5.

Each brake circuit I, II is connected to the master brake cylinder 4 via an isolation valve 6. The wheel brakes 2 are each connected to the isolation valves 6 via an inlet valve 7. The wheel brakes 2 in each brake circuit I, II are connected via outlet valves 8 to an intake side of a hydraulic pump 9, which are also referred to as return pumps. A hydraulic accumulator 10 and a check valve 11 through which fluid can flow in the direction of the hydraulic pump 9 are arranged between the outlet valves 8 and the hydraulic pumps 9. Delivery sides of the hydraulic pumps 9 are connected between the isolation valves 6 and the inlet valves 7, such that the hydraulic pumps 9 can convey brake fluid exiting the wheel brakes 2 via the inlet valves 7 back into the wheel brakes 2 or via the isolation valves 6 back into the master brake cylinder 4, by means of the outlet valves 8 being opened during slip control, in order to increase the pressure again in the wheel brakes 2.

The hydraulic pumps 9 can be driven together by means of an electric motor 12. The intake sides of the hydraulic pumps 9 are not only connected to the wheel brakes 2 via the outlet valves 8, but also to the master brake cylinder 4 via intake valves 13 for a rapid build-up of brake pressure.

According to the invention, a pressure-change damper 14 and a throttle 15 are provided between the delivery sides of the hydraulic pumps 9 and the connection thereof between the isolation valves 6 and the inlet valves 7. The pressure-change damper 14 and the throttle 15 dampen pressure oscillations, pressure pulses and, in particular, sudden pressure changes in the brake fluid caused by switching of the valves and caused by a periodic conveyance of the brake fluid by means of the hydraulic pumps 9 if these are designed, for example, as piston pumps.

In the embodiment shown, valves are 2/2-way solenoid valves, the isolation valves 6 and the inlet valves 7 being open in their de-energized basic positions and the outlet valves 8 and the intake valves 13 being closed in their de-energized basic positions. The inlet valves 7 and outlet valves 8 form wheel brake pressure modulation valve assemblies by means of which, together with the hydraulic pumps 9, wheel brake pressures in the wheel brakes 2 can be controlled for individual wheels for the purpose of slip control. Slip control systems of this kind are, for example, anti-lock braking systems, traction control systems and/or dynamic stability control/electronic stability programs for which the abbreviations ABS, TCS and/or DSC/ESP are common. Slip control systems are known and are not explained in more detail here.

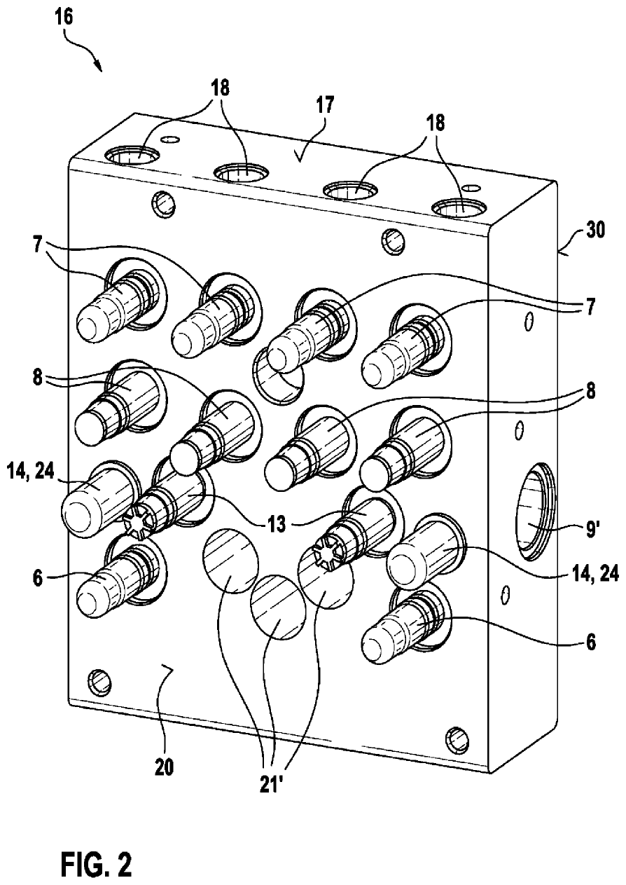

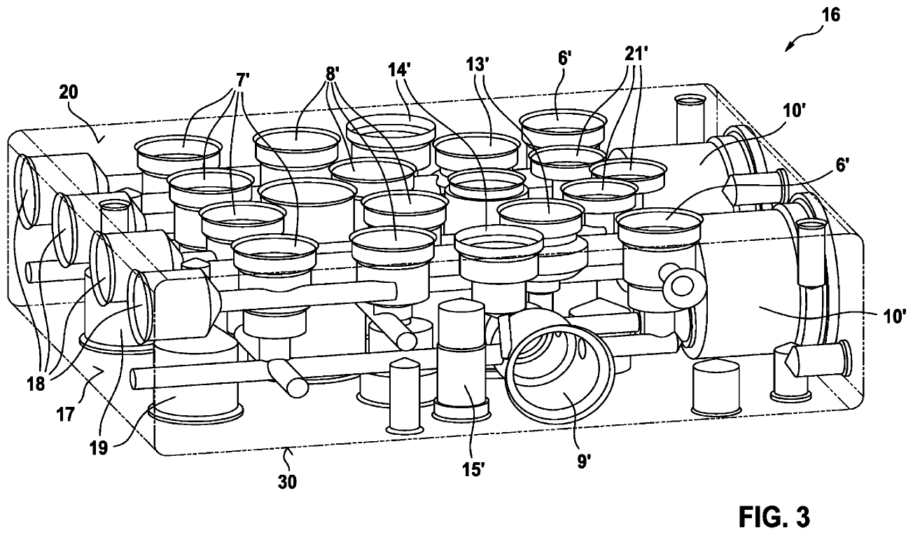

The isolation valves 6, inlet valves 7, outlet valves 8, hydraulic pumps 9, hydraulic accumulators 10, check valves 11, intake valves 13, pressure-change dampers 14, and throttles 15 are accommodated in a hydraulic block 16 according to the invention, which is shown in FIGS. 2 and 3. When equipped with the above-mentioned hydraulic components, the hydraulic block 16 forms a hydraulic assembly for the slip control system of the hydraulic vehicle braking system 1. The hydraulic block 16 or the hydraulic assembly is connected to the master brake cylinder 4 via brake lines and, likewise, the wheel brakes 2 are connected to the hydraulic block 16 or to the hydraulic assembly via brake lines.

In the embodiment, the hydraulic block 16 according to the invention shown in FIGS. 2 and 3 is a cuboid metal block that has almost square large sides and that is approximately one quarter to one third as thick as it is long or wide. The hydraulic block 16 comprises blind holes as receptacles for the solenoid valves 6, 7, 8, 13, the check valves 11, the hydraulic accumulators 10, pressure-change dampers 14, and the throttles 15, and a through-hole as a receptacle for the hydraulic pumps 9. The electric motor 12 is arranged on the outside on one of the two large sides of the hydraulic block 16, which is referred to here as the motor side 30 of the hydraulic block 16. The receptacles for the hydraulic components accommodated in the hydraulic block 16 are denoted by the reference numbers for the components with the addition of a “′”.

In a transverse side of the hydraulic block 16, designated here as the connection side 17, four blind holes are made in a row one next to the other as connections 18 for the brake lines leading to the wheel brakes 2. The connections 19 for the two brake lines coming from the master brake cylinder 4 are attached in the motor side 30 of the hydraulic block 16 close to the connection side 17, which motor side is located at the rear facing away from the observer in FIG. 2 and at the bottom in FIG. 3. The brake lines are fastened in the connections 18, 19 in a pressure-tight manner, for example by means of screw nipples or press-in nipples, also so-called “self-clinching” press-in nipples. In FIG. 3, the hydraulic block 16 is transparent, such that the receptacles for the hydraulic components and the connections 18, 19 for the brake lines are visible.

The receptacles for the solenoid valves are located in a large side of the hydraulic block 16 opposite the motor side 30, which large side is referred to here as the valve side 20. The total of four receptacles 7′ for the inlet valves 7 are arranged one next to the other in a first valve row parallel to the connection side 17, the four receptacles 8′ for the outlet valves 8 are likewise arranged one next to the other in parallel with the connection side 17 in a second valve row, the receptacles 13′ for the intake valves 13 are arranged in a third valve row, and the receptacles 6′ for the isolation valves 6 are arranged in a fourth valve row, the four valve rows being arranged in the aforementioned order between the connection side 17 and an opposite transverse side of the hydraulic block 16 on the valve side 20 thereof. The hydraulic block 16 comprises receptacles 21′ for pressure sensors 21 between the receptacles 6′ for the isolation valves 6. In the transverse side opposite the connection side 17, the hydraulic block 16 comprises blind holes as receptacles 10′ for the hydraulic accumulators 10. The receptacles for the hydraulic components are connected to one another in accordance with the hydraulic circuit diagram of the vehicle braking system 1 by means of bores in the hydraulic block 16. The bores, the receptacles, and the connections can also be referred to as the bored elements of the hydraulic block 16. When equipped with the hydraulic components, the hydraulic unit 16, as already mentioned, forms the hydraulic assembly for the slip control system of the vehicle braking system 1.

The through-hole forming the receptacle 9′ for the hydraulic pumps 9 extends through the hydraulic block 16 in parallel with the two large sides of the hydraulic block 16, i.e. in parallel with the motor side 30 and the valve side 20, and in parallel with the two transverse sides, i.e. in parallel with the connection side 17 and the transverse side opposite thereto, between the second valve row having the receptacles 8′ for the outlet valves 8 and the third valve row having the receptacles 13′ for the intake valves 13.

In FIG. 2, valve domes containing solenoid armatures of the solenoid valves protrude from the hydraulic block 16 on the valve side 20. Magnet coils (not shown) for actuating the solenoid valves are placed on the valve domes. With the exception of the valve domes, the hydraulic block 16 according to the invention is shown unequipped in FIG. 2. In FIG. 3, the hydraulic block 16 according to the invention is shown unequipped and transparent in order to make the receptacles visible.

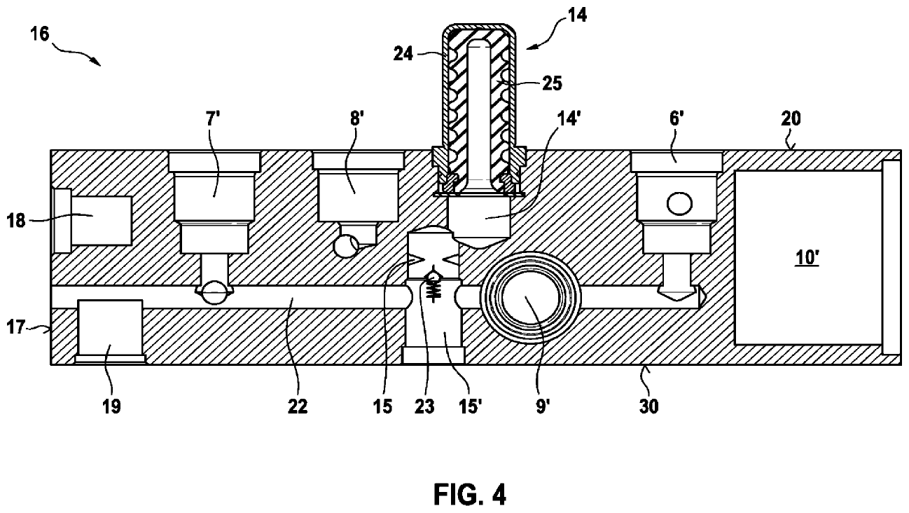

In the third valve row, the hydraulic block 16 according to the invention comprises two blind holes in the valve side 20 as receptacles 14′ for the pressure-change dampers 14 outside the receptacles 13′ for the intake valves 13, i.e. the receptacles 13′ for the intake valves 13 are located between the receptacles 14′ for the pressure-change dampers 14. The receptacles 14′ for the pressure-change dampers 14 are offset in relation to the receptacles 9′ for the hydraulic pumps 9 in the direction of the transverse side of the hydraulic block 16 opposite the connection side 17. The offset is so small that imaginary cylindrical envelope surfaces of the receptacles 14′ of the pressure-change dampers 14 intersect the receptacles 9′ of the hydraulic pumps 9. However, the receptacles 14′ of the pressure-change dampers 14 are so short that they do not open into the receptacles 9′ of the hydraulic pumps 9. This can be seen in FIG. 4, which is a longitudinal section of the hydraulic block 16 parallel to the longitudinal sides thereof, i.e. perpendicular to the connection side 17, to the motor side 30, and to the valve side 20, axially through one of the two receptacles 14′ for the pressure-change dampers 14. As can be seen in FIGS. 3 and 4, the receptacles 14′ for the pressure-change dampers 14 and the receptacles 9′ for the hydraulic pumps 9 are attached at right angles to one another and at an offset to one another in the hydraulic block 16.

As shown in FIG. 4, the pressure-change dampers 14 comprise a cylindrical tube-shaped housing 24, which is closed at one end and the open end of which is arranged in an opening of the receptacles 14′ and is fastened in a pressure-tight manner in the receptacle 14′ by means of a circumferential press-fit. Like the valve domes of the solenoid valves, the housings 24 of the pressure-change dampers 14 protrude from the valve side 20 of the hydraulic block 16. Thick-walled, tubular damping bodies 25 are located in the housings 24, one end of which damping bodies is closed and the open end of which opens into the receptacle 14′. The damping bodies 25 consist of an elastomer foam and dampen pressure changes of brake fluid in their interior.

In the motor side 30, i.e. in the side of the hydraulic block 16 which lies opposite the valve side 20 having the receptacles 14′ for the pressure-change dampers 14, blind holes are made in the hydraulic block 16 as receptacles 15′ for the throttles 15 (see FIGS. 3 and 4). The receptacles 15′ for the throttles 15 and the receptacles 14′ for the pressure-change dampers 14 are parallel to one another; they have axes parallel to one another. In other words, like the receptacles 14′ for the pressure-change dampers 14, the receptacles 15′ for the throttles 15 also extend at right angles to the receptacles 9′ for the hydraulic pumps 9. Like the receptacles 14′ for the pressure-change dampers 14, the receptacles 15′ for the throttles 15 are offset with respect to the receptacles 9′ for the hydraulic pumps 9 in the direction of the transverse side of the hydraulic block 16 opposite the connection side 17, but the offset of the receptacles 15′ for the throttles 15 is greater, and therefore the receptacles 15′ for the throttles 15 do not intersect the receptacles 9′ for the hydraulic pumps 9. However, the offset of the receptacles 15′ for the throttles 15 is so small that the receptacles 15′ for the throttles 15 open into the receptacles 14′ for the pressure-change dampers 14, as can be seen in FIGS. 3 and 4. In FIG. 4, the throttle 15 is shown symbolically as a pin diaphragm in the receptacle 15′ thereof, however the throttles 15 may also be designed differently. In addition, FIG. 4 shows a check valve 23 as a circuit symbol in the receptacles 15′ for the throttles 15. A check valve 23 of this kind may be but does not have to be present. Bores 22, which are parallel to the valve side 20, to the motor side 30, and to the longitudinal sides of the hydraulic block 16 and which extend from the connection side 17 into the hydraulic block 16, pass through the receptacles 9′ for the hydraulic pumps 9 and the receptacles 15′ for the throttles 15. The bores 22, which are part of the bored elements of the hydraulic block 16, are arranged in the hydraulic block 16 in such a way that they connect the delivery sides of the hydraulic pumps 9 to the receptacles 15′ for the throttles 15, to the receptacles 7′ for the inlet valves 7, and to the receptacles 6′ for the isolation valves 6 when said pumps are arranged in their receptacles 9′ in the hydraulic block 16. The receptacles 14′ for the pressure-change dampers 14 are connected to the delivery sides of the hydraulic pumps 9 via the receptacles 15′ for the throttles 15, into which they open.

1. A hydraulic block for a hydraulic assembly for a slip control system of a hydraulic vehicle braking system, comprising;
receptacles for valves of the slip control system;
a receptacle for a hydraulic pump;
a receptacle for a pressure-change damper in one side of the hydraulic block; and
a receptacle for a throttle in another side of the hydraulic block.

2. The hydraulic block according to claim 1, wherein the receptacle for the pressure-change damper and the receptacle for the throttle are arranged in opposite sides of the hydraulic block.

3. The hydraulic block according to claim 2, wherein the receptacle for the pressure-change damper and the receptacle for the throttle have parallel axes.

4. The hydraulic block according to claim 1, wherein the receptacle for the pressure-change damper and the receptacle for the throttle are arranged at an offset in relation to one another.

5. The hydraulic block according to claims claim 1, wherein the receptacle for the pressure-change damper and the receptacle for the throttle intersect one another or open into one another.

6. The hydraulic block according to claim 1, wherein the receptacle for the pressure-change damper and/or the receptacle for the throttle are arranged at an offset in relation to the receptacle for the hydraulic pump.

7. The hydraulic block according to claim 1, further comprising:
a bored element configured to (i) connect a delivery side of the hydraulic pump arranged in the receptacle for the hydraulic pump to the receptacle for the pressure-change damper, and (ii) connect the delivery side of the hydraulic pump arranged in the receptacle for the hydraulic pump and/or the receptacle for the pressure-change damper to the receptacle for the throttle.
